(19) United States
(12) Patent Application Publication
(10) Pub. No.: US 2022/0355549 A1
(43) Pub. Date: Nov. 10, 2022

(54) REMOVING OBJECTS FROM A VOLUME OF BUILD MATERIAL

(71) Applicant: Hewlett-Packard Development Company, L.P., Spring, TX (US)

(72) Inventors: Arturo Garcia Gomez, Sant Cugat del Valles (ES); Pablo Antonio Murciego Rodriguez, Sant Cugat del Valles (ES)

(21) Appl. No.: 17/623,516

(22) PCT Filed: Oct. 23, 2019
(86) PCT No.: PCT/US2019/057602

§ 371 Date: Dec. 28, 2021

(51) Int. Cl. B29C 64/379; B33Y 10/00; B33Y 30/00; B33Y 40/00; B29C 64/245; B29C 64/255; B29C 64/165; B22F 10/14; B22F 12/30; B22F 12/70

(52) U.S. Cl. CPC B29C 64/379; B33Y 10/00; B33Y 30/00; B33Y 40/00; B29C 64/245; B29C 64/255; B29C 64/165; B22F 10/14; B22F 12/30; B22F 12/70

(57) ABSTRACT

According to an example, a device comprises a sidewall and a base. The sidewall and the base define a chamber for receipt of a volume of build material comprising loose build material and a solid object generated from the build material in an additive manufacturing process. The base is not permeable to build material but permeable to a gas to allow an influx of a gas into the chamber to fluidize loose build material around the solid object in the volume of build material in the chamber to facilitate the removal of the solid object from the loose build material.

### BACKGROUND

Some additive manufacturing systems generate three-dimensional objects on a layer-by-layer basis through the selective solidification of build material.

### BRIEF DESCRIPTION OF DRAWINGS

Examples will now be described, by way of non-limiting example, with reference to the accompanying drawings, in which:

FIG. 1 is a simplified schematic of an example device;

FIG. 2 is a simplified schematic of an example 3D printing apparatus comprising an example device;

FIG. 3 is a simplified schematic of an example device;

FIG. 4 is a simplified schematic of an example device;

FIG. 5 is a flowchart of an example of a method;

FIG. 6 is a flowchart of an example of a method;

FIG. 7 is a flowchart of an example of a method;

FIG. 8 is a simplified schematic cross-sectional view of an example apparatus.

### DETAILED DESCRIPTION

Additive manufacturing techniques may generate a three-dimensional object through the solidification of a build material. In some examples, the build material may be a powder-like granular material, which may for example be a plastic, ceramic or metal powder. The properties of generated objects may depend on the type of build material and the type of solidification mechanism used. Build material may be deposited, for example on a print bed and processed layer by layer, for example within a fabrication chamber. According to one example, a suitable build material may be PA12 build material commercially known as V1R10A “HP PA12” available from HP Inc.

In some examples, selective solidification is achieved through directional application of energy, for example using a laser or electron beam which results in solidification of build material where the directional energy is applied. In other examples, at least one print agent may be selectively applied to the build material, and may be liquid when applied. For example, a ‘coalescence agent’ or ‘coalescing agent’ (for example, a fusing agent in examples where the build material comprises a plastics powder, or a binder agent in examples where the build material comprises a metal powder) may be selectively distributed onto portions of a layer of build material in a pattern derived from data representing a slice of a three-dimensional object to be generated (which may for example be generated from structural design data). The fusing agent may have a composition which absorbs energy such that, when energy (for example, heat) is applied to the layer, the plastic build material coalesces and solidifies to form a slice of the three-dimensional object in accordance with the pattern. The binder agent may have a composition that, when heated or when UV energy is applied, causes the metal particles of build material to which binder agent is applied to adhere to one another. In other examples, coalescence may be achieved in some other manner.

According to one example, a suitable fusing agent may be an ink-type formulation comprising carbon black, such as, for example, the fusing agent formulation commercially known as V1Q60A “HP fusing agent” available from HP Inc. In one example such a fusing agent may additionally comprise an infra-red light absorber. In one example such a fusing agent may additionally comprise a near infra-red light absorber. In one example such a fusing agent may additionally comprise a visible light absorber. In one example such a fusing agent may additionally comprise a UV light absorber. Examples of print agents comprising visible light enhancers are dye based colored ink and pigment based colored ink, such as inks commercially known as CE039A and CE042A available from HP Inc.

As noted above, additive manufacturing systems may generate objects based on structural design data. This may involve a designer generating a three-dimensional model of an object to be generated, for example using a computer aided design (CAD) application. The model may define the solid portions of the object. To generate a three-dimensional object from the model using an additive manufacturing system, the model data can be processed to generate slices of parallel planes of the model. Each slice may define a portion of a respective layer of build material that is to be solidified or caused to coalesce by the additive manufacturing system.

As noted above, additive manufacturing systems may generate objects through the selective solidification of a build material comprising plastic particles or metal particles (for example a stainless steel powder). This may involve depositing build material in layers on a print bed, or build platform and selectively depositing a fusing agent (in examples where the build material comprises plastic particles) or a binder agent (in examples where the build material comprises metal particles), for example using printheads to jet the agent, onto portions of a layer of build material in a pattern derived from data representing a slice of a three-dimensional object to be generated (which may, for example, be generated from structural design data). When heat is applied to a layer of build material, those portions of build material to which fusing agent (or binder agent) was applied will heat and coalesce.

In the example of a plastics build material, the portions of build material treated with fusing agent absorb energy (e.g. heat energy), coalesce, and solidify to form a slice of the three-dimensional object in accordance with the pattern. Following the application of energy therefore, the portions of build material to which fusing agent was applied heat up, coalesce, and then solidify upon cooling to form the three-dimensional object. Any build material to which fusing agent was not applied (un-coalesced, “loose” build material, or build material remnant), e.g. those parts of the build material that will not form part of the generated object, will not solidify and remain as un-coalesced, loose, excess, build material. Following the application of energy, therefore, the three-dimensional object may therefore be embedded and/or at least partially surrounded by un-coalesced, loose, build material which will need to be separated from the object prior to any subsequent operations (e.g. a post-processing operation such as dyeing).

In the example of a metal build material, the binder agent may comprise an adhesive element (for example a polymeric concentrate) suspended within a liquid carrier that will cause portions of build material to which binder agent was applied to coalesce during a curing process. For example, following the layer-wise deposition of the metal build material and the selective deposition of the binder agent thereon the build platform and/or the powder contain therein may undergo a curing process during which the build material (including the layers of build material with the binder agent applied and surrounding build material to which no binder agent has been applied) is subjected to heat or UV light. The temperature may vary depending on the composition of the build material or other factors. In one example, the curing temperature may be 300° C. or less. In one example, the curing temperature may be between 50° C. and 300° C., for example between 50° C. and 200° C. In yet another example, the curing temperature may be between 50° C. and 70° C., for example approximately 50° C. In other examples, the build material may be cured via exposure to UV light. During the curing process, the binder agent, applied to portions of the build material, is thermally activated when subject to the curing temperatures, causing adhesive particles (e.g. polymeric particles) to separate from the liquid carrier and adhere to particles of the build material while the liquid carrier evaporates, leaving the portions of build material to which binder agent was applied solidifying and effectively being glued together. Post-curing, any build material to which binder agent was not applied (“loose” build material, or build material remnant), e.g. those parts of the build material that will not form part of the generated object, will not solidify and remain as loose, excess, build material. Curing may be performed on a plurality of layers of build material, in other words a whole volume of build material may be subject to heat to cure the whole volume of build material at substantially the same time. For the curing process, the build platform may be moved to a separate curing station comprising a curing oven or similar.

After curing, the solidified build material (those portions of the build material to which binder agent was applied and have adhered during curing due to the activation of the adhesive) may be referred to as a “green part”, being unfinished but substantially resembling the final part, and being a loosely bound part having a relatively low density. Once cured, to form the final object to be generated from the metal build material, the green part is transferred to a sintering oven in which the green part undergoes a sintering process. During sintering, the green part is exposed to elevated temperatures to sinter the build material particles (of the green part) into the final, solid, three-dimensional object (which will have a higher density than the green part). The temperature may depend on the composition of the build material and, for example, may be below the full melting temperature of the build material. The sintering temperature may, in some examples, be approximately between 0% and 20% below the melting temperature for a particular build material. For example, the build material may comprise aluminium alloy particles and sintering of the green part made of aluminium alloy particles may be performed at a sintering temperature that is between 590° C. and 620° C. In examples where the build material comprises copper, green parts made of copper powder may be sintered at temperatures between 750° C. and 1000° C. For example, where the build material comprises brass powder, the resulting green part may be sintered between 850° C. and 950° C. For a build material comprising stainless steel (for example comprising stainless steel powder) the green part may be subject to a temperature of between 1100° C. and 1400° C. or, for example, a temperature of over 1300° C. but not higher than 1380° C. and 1400° C., e.g. for 316L stainless steel alloys.

In either example, e.g. printing with a plastics or a metal build material, the three-dimensional object is removed from a build material volume (comprising coalesced build material forming the object at least partially surrounded by un-coalesced, loose, build material—this volume sometimes being referred to as the “build bed”) prior to undergoing any post-processing. For example, in an additive manufacturing process using metal build material, after curing and prior to sintering, the green part undergoes a post-processing operating during which the green part is cleaned in order to remove excess powder (e.g. excess build material) in a process often referred to as “de-caking”. The de-caking process is so that any remaining build material (build material remnant or “caked” powder) can be removed from the green part since, if not removed, the remaining build material may fuse during the sintering process which could create anomalies in the geometry of the final part.

A three-dimensional object formed by the selective coalescing of portions of build material, may therefore need to be removed from its position within a bed of hot, un-coalesced, and loose powder. Un-coalesced, loose, build material may also be removed from the surfaces of the object. To do this, the build-bed may need to be cooled since the final temperature of the object, and any surrounding loose build material, following the application of energy, or curing, may be too hot for manual handling, or cooling of the build material in the build bed may be needed to reduce the risk of damage, for example the risk of exploding build material (since the minimum ignition energy of build material decreases with an increase in temperature of the build material), and the risks of damaging any hardware used to transport the hot build material.

Some examples herein relate to injecting a gas (e.g. air) into the build bed to fluidize any loose, uncoalesced, build material at least partially surrounding a 3D printed part, or printed parts, embedded in the build bed. In this process, a gas (e.g. air) is injected into the build bed will move through the loose, uncoalesced build material through the empty spaces between the particles of the loose build material. This, in turn, causes the loose build material particles to move relative to one another (e.g. away from and towards each other) which my eventually cause all the loose build material in the build bed to move. Increasing the velocity at which gas (e.g. air) is injected will cause the build bed to expand in volume as the build material particles continue to move further away from each other. Eventually, the loose build material in the build bed exhibits fluidic behaviour. In other words, the solid bed of loose build material becomes dynamic like a fluid, in the sense that the fluidized loose build material may behave as a fluid. For example, the fluidized loose build material may exhibit a property of a fluid, for example it may have no fixed shape, may substantially conform to a volume of a container holding the build material, easily and/or continually deform under an applied external force, be flowable, not resist permanent deformation, etc.

Fluidizing the loose build material in the build bed may facilitate cooling the build bed and the removal of a 3D printed part, or 3D printed parts, therefrom. For example, gas circulating in between the particles of loose build material may cause the loose build material to cool down at a quicker rate. This, in turn, may cause gas and build material to circulate around a 3D printed part (or parts) embedded in the build bed which may cause the 3D printed part to cool down at a quicker rate. In other words, the fluidized, loose, build material may cause a faster rate of transfer of heat from a 3D printed part to the environment via circulating gas and loose build material.

This, in turn facilitates removal of the 3D printed part from surrounding (uncoalesced) build material since it effectively turns a situation where the 3D printed part is removed from a solid powder volume to a situation where the 3D printed part is removed from a fluid. In other words, removal of the 3D printed part may from surrounding build material may become easier the more the uncoalesced build material is caused to move around the part (e.g. through the process of fluidization). In turn, this reduces the risk of damage to the part during the removal of the part, as the part is being removed from a fluid, flowing, volume of powder.

Some examples herein therefore relate to a means of fluidizing build material to cool down the object and any surrounding, loose, build material. This may allow for a quicker de-caking since the time between the end of the print job and de-caking may be reduced. The fluidized powder also allows for a gentler removal of a 3D printed part from a volume of build material which, in turn, may reduce the likelihood of damage to the part during removal. Some examples herein therefore allow for a better control of the rate at which printed 3D objects may cool down and an expedient, and easy-to-automate, method of removing non-coalesced powder from around printed objects.

According to some examples herein there is provided a device, or an apparatus, to receive a volume of build material containing a 3D printed part (or parts), generated in an additive manufacturing process as described above, from build material comprising plastic or metal particles, at least partially surrounded by un-coalesced, loose, build material as also described above. These devices, or apparatus, may comprise a surface which comprises openings, or pores, that do not allow build material to pass therethrough, but are permeable to air (for example, compressed air) such that an air stream may, through this surface, enter the build bed to “fluidize” the un-coalesced, loose, build material in the build bed, a process that will cause the (at least partially surrounding) loose build material to exhibit the characteristics of a fluid enabling a faster removal of the object from the loose build material. The air that is injected into the volume of build material to fluidize the loose, uncoalesced, plastic or metal particles of build material may be selected to achieve a target temperature of the build material. Through the fluidization of the powder, after a time the build material reaches a target temperature (e.g. suitable for handling the object embedded in the build material volume). Air may be injected at a first temperature, and the temperature may be controller and/or chosen to achieve a target temperature. Although air is utilised to describe the fluidization process for the examples presented herein, in some examples, a gas is injected to the volume of build material to fluidize the build material. For example, a gas comprising nitrogen, may be used (and the chosen gas may be to prevent the oxidisation of build material, depending on the composition of build material).

Some examples herein relate to the generating, in an additive manufacturing process, for example according to the same additive manufacturing process that generated the object, a structure (for example a cage-like structure) that at least partially surrounds the object, such removing the structure from the build bed removes the object.

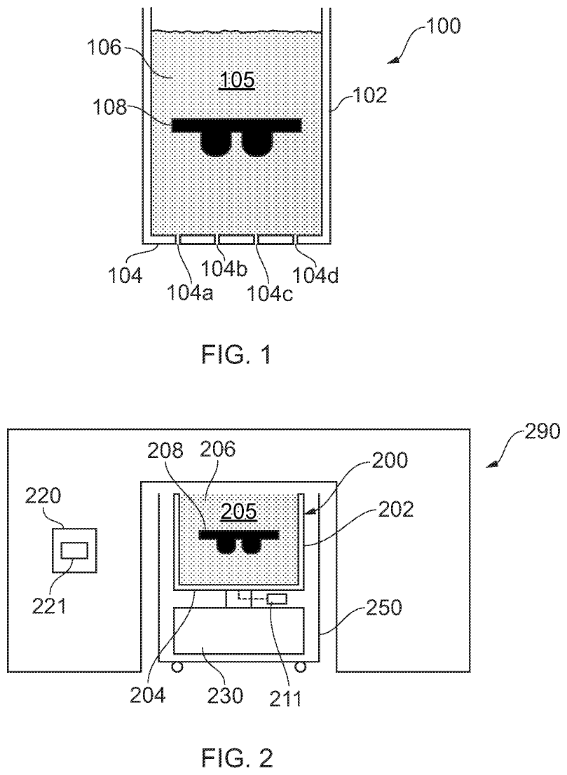

FIG. 1 shows a device 100 comprising a sidewall 102 and a base 104. The sidewall 102 and the base 104 define a chamber for receipt of a volume 105 of build material. In other words, the sidewall 102 and the base 104 may at least partially delimit the dimensions of an internal chamber of the device 100 that is to receive a volume 105 of build material. The volume 105 of build material comprises loose build material 106 and a solid object 108 generated from the build material in an additive manufacturing process, for example as described above. For example, the volume of build material 105 may be the result of an additive manufacturing process in which layers of build material are selectively deposited onto a platform (which may, as described below comprise the base 104) and fusing agent (for plastic build material) or binder agent (for metal build material) is applied to portions of layers of build material that, following the application of energy, will coalesce to form the object 108 (shown for purely illustrative purposes here as a pair of sunglasses to illustrate one example). Following this process, the object 108 is therefore embedded, and/or at least partially surrounded in untreated build material 106 (build material to which no fusing agent or binder agent was applied), in other words, loose, uncoalesced build material 106. Although one object 108 is depicted in FIG. 1 in some examples a plurality of objects may be in the build bed at least partially surrounded by untreated build material.

The base 104 is not permeable to build material but is permeable to air. The base 104 may comprise a porous Aluminium alloy. The base 104 may comprise a mesh, such as a sieve, sandwiched between two plates having pores for the passage of air. The base 104 is therefore to allow the influx of air into the chamber and therefore into the volume 105 of build material to fluidize the loose (e.g. uncoalesced) build material 106 around the solid object 108 in the volume 105 of build material to facilitate the removal of the (or each) solid object 108 from the loose build material 106. For this purpose, the base 104 is schematically depicted with pores (four are shown 104a-d for the purposes of illustration; it will be appreciated that the base may comprise any number of pores). Each pore 104a-d is therefore sized to allow the passage of air but not build material. In one example, each pore 104a-d may comprise a diameter of 50 μm or less. In other examples, the pores may be larger but the base may comprise a membrane on top of the pores, the membrane being permeable to air but not to build material. In these examples, although the pores themselves may be sized to accommodate build material therein the membrane does not allow for the passage of build material therethrough. Accordingly, in some examples the base 104 may comprise a membrane permeable to air but not to build material. In this way, the base 104 is able to retain the volume 105 of build material in the chamber (e.g. so that build material will not fall through the base 104) but will allow an influx of air to fluidize loose build material 106. Although not shown in FIG. 1, in some examples, the device 100 may comprise a top surface, such as a lid. In these examples the lid may comprise a vent, for example to prevent an overpressure from being generated inside the device 100 when the loose build material therein is fluidized.

FIG. 2 shows a 3D printing apparatus 290 and a device 200, which may comprise the device 100 of FIG. 1. The device 200 comprises a sidewall 202 and a base 204 defining a chamber for receipt of a volume 205 of build material comprising loose build material 206 and a solid object 208 generated from the build material in an additive manufacturing process. The printing apparatus 200 of FIG. 2 may be to perform the additive manufacturing process. The solid object 208 in some examples may comprise a plurality of solid objects.

As for the device 100 of FIG. 1, the base 204 of the device 200 of FIG. 2 is not permeable to build material but is permeable to air to allow an influx of air into the volume 205 of build material to fluidize the loose build material 206 at least partially surrounding the solid object 208 in the volume 205 of build material to facilitate the removal of the solid object 208 from the loose build material 206. For this purpose, the device 200 in this example comprises an airflow source 211 to inject air into the volume 205 through the base 204 to fluidize the loose build material 206. The base 204 may comprise a porous aluminium alloy and may comprise a mesh, such as a sieve, sandwiched between two plates having pores for the passage of air. In other examples the base 204 may comprise a membrane, the membrane being permeable to air but not to build material.

The 3D printing apparatus 290 shown in FIG. 2 may comprise processing circuitry 220 comprising a control module 221. The control module 221 may be to control the 3D printing apparatus 290 to generate the solid object 208 (e.g. in an additive manufacturing process by causing portions of successive layers of build material to coalesce and form the object 208 (e.g. according to object model data which may be operated on by the processing circuitry 220). In other words, the 3D printing apparatus may cause build material (which may comprise plastic or metal particles) stored in a build material reservoir 230, or tank, of the apparatus 290 to be deposited in layers onto a platform and cause the selective application of a coalescence agent (e.g. a fusing agent or a binder agent) to portions of layers of build material that correspond to the object to be generated. In examples where the build material comprises plastic particles the printing apparatus 290 may additionally be to apply energy (e.g. heat energy) to each layer of build material, e.g. on a layer-by-layer basis, to cause the portions of build material to which fusing agent was applied to coalesce. In either example, a trolley 250 is moveable into and out of the printing apparatus 290 and, in this example, comprises the build material reservoir 230 and the device 200. In other examples the trolley 250 may comprise the device 200 and the build material reservoir 230 may be remote from the trolley 250.

In one example therefore, the device 200 may comprise a build unit of the 3D printing apparatus 290 and the base 204 of the device 200 comprises the movable base of the build unit, for example the print bed. In these examples, the device 200 may comprise a removable build unit. In other words, the build unit may be movable relative to the 3D printing apparatus 290 (which may comprise the build unit). The build unit may then be removable from the 3D printing apparatus. In other examples the build unit may not be movable relative to the 3D printing apparatus, e.g. the build unit may be a fixed build unit. The device 200 of the FIG. 2 example may comprise a removable build unit or a fixed build as hereinbefore described. The chamber (defined by the sidewall 202 and base 204) of this example therefore comprises the fabrication chamber of the 3D print apparatus 290. In operation when the apparatus 290 is performing a print job, the base 204 of the device is positioned at an uppermost position and a layer of build material is applied onto the base 204 (the build material may be directed from the reservoir 230). Fusing agent (or binder agent) is then selectively applied, e.g. under the control of the control module 221, to portions of the layer which become be part of the object (e.g. according to object model data) and, in the case of plastic build material, heat is also applied to fuse those portions of the layer. The base 204 is then moved downwards an incremental amount and another layer of build material is deposited. FIG. 2 depicts the device 200 at the end of the printing process in which the base 204 is moved to a lowermost position and the chamber (e.g. the fabrication chamber) of the device 200 comprises a volume 205 of build material comprising both the solid object 208 and loose, uncoalesced, build material. The trolley 250 may then be removed from the apparatus 290 and taken to a remote location for cooling and/or de-caking. In other examples the cooling and/or de-caking may take place when the trolley 250 is received in the apparatus 290, as shown in FIG. 2. In either example, air from air source 211 may be caused to enter the volume of build material 205 through the base 204 to fluidize the loose build material 206 contained therein which may cool the object 208 and facilitate the removal of the (or each) object 208 from the surrounding, fluidized, build material 206. In these examples, the base 204 may be a detachable base of a build unit such that, the base 204 may facilitate the removable of the build material volume from the build unit to an external contained, and the base 204 may form the base of that external container. This allows the volume of build material to be moved to a cooling and/or de-caking station. Accordingly, in some examples herein the base 204 is a removable base of a build unit that is permeable to air but not to build material. Although not shown in FIG. 2, in some examples, the device 200 may comprise a top surface, such as a lid. In these examples the lid may comprise a vent, for example to prevent an overpressure from being generated inside the device 200 when the loose build material therein is fluidized.

In another example, the device (e.g. the device 100 of FIG. 1) may not be a component of the build unit of a printing apparatus but may be a separate device. For example, in some additive manufacturing operations, following a print job the volume of build material (e.g. the build bed comprising a 3D printed object at least partially surrounded by uncoalesced, loose, build material) may be moved to a location remote from the 3D printing apparatus for subsequent cooling and de-caking. In these examples, the volume of build material may be transferred to another device, leaving the build unit to be used in another printing operation.

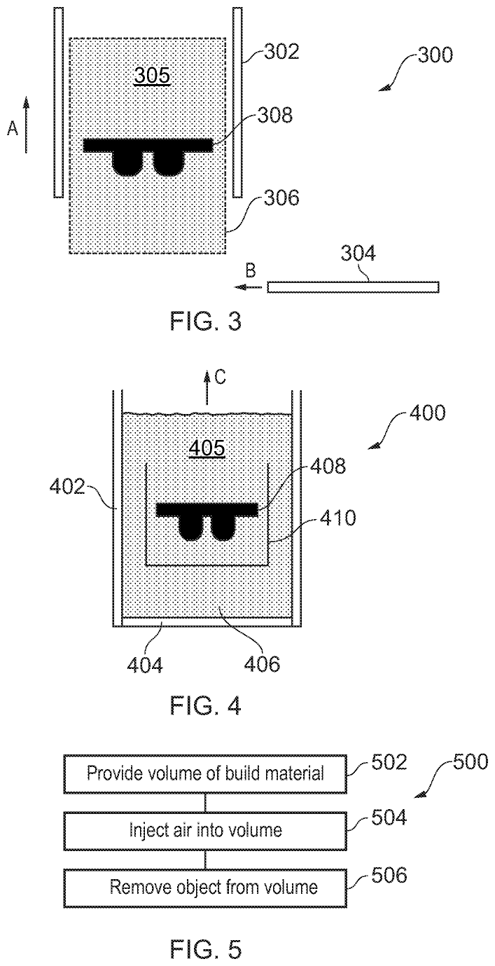

FIG. 3 shows an example device 300 which may be to receive a volume 305 of build material (e.g. the volumes 105 or 205 as described above). In this example, the device 300 is separate from the printing apparatus and is not a component of a build unit. The device 300 comprises a sidewall 302 and a base 304 that define a chamber for receipt of a volume 305 of build material (comprising a solid object 308 generated in an additive manufacturing process and uncoalesced, loose, material 306 at least partially surrounding the object 308) and the base 304 is not permeable to build material but permeable to air to allow an influx of air to fluidize the loose build material 306. The base 304 may comprise a porous aluminium alloy and may comprise a mesh, such as a sieve, sandwiched between two plates having pores for the passage of air. In other examples the base 204 may comprise a membrane, the membrane being permeable to air but not to build material. The solid object 308 in some examples may comprise a plurality of solid objects. As will be explained below, as in this example the sidewall 302 is moveable relative to the volume 305 of build material.

In the example of FIG. 3, the solid object 308 was generated in an additive manufacturing process, such as that described above with reference to FIG. 2. For example, the volume 305 of build material containing the solid object 308 may comprise the volume 205 as described above with reference to FIG. 2. A trolley of a printing apparatus (such as trolley 230 in the FIG. 2 example), containing the volume 305, may have been removed from a printing apparatus so that the volume 305 may be transferred to the device 300, which may therefore allow the transportation of the volume of build material to a cooling and/or de-caking station. The device 300 in this example may therefore comprise an external container to allow transportation and/or storage of a volume of build material.

The base 304 of the device 300 in this example is moveable with respect to the sidewall 302 and insertable into, and removable from, the device 300. FIG. 3 shows build volume 305 being moved relative to the sidewall 302 of the device 300, and being inserted into the device 300 such that the volume 305 is at least partially surrounded by the sidewall 302. The arrow A represents the direction of movement of the volume 305 so that sidewall 302 is disposed around at least part of the volume 305, at least partially containing the volume 305 therein. The base 304 of the device 300 is moved in the direction of arrow B to form a base, or lower platform, to retain the volume 305 of build material. The resulting device is similar to the configuration shown in FIG. 1 but in the FIG. 3 examples the sidewall 302 was inserted around the volume 305 and the moveable base 304 was inserted below the volume 305 to effectively assemble the device 300 around the volume 305. The device 300 is therefore insertable around the volume 305 of build material and is effectively build around the volume 305 of build material.

In some examples, the removable base 304 may be referred to as a “guillotine” as the base 304 effectively ‘cuts’ the volume 305 of powder when it is inserted in the direction B. The device 300 is therefore effectively a storage device 300 for the volume 305 of build material that can be transported to a location remote from a 3D printing apparatus (in which the object 308 was generated), e.g. to a cooling and/or de-caking station, to cool and for removal of the (or each) object 308. For removing the object 308 once the volume 305 of build material is retained by the device 300, air may be introduced into the volume 305 of build material through the base 304 to fluidize the uncoalesced, loose, build material 306 in the volume 305 and the objet 308 may then be removed from the fluidized build material 306. Fluidization in this example may therefore occur remote from a 3D printing apparatus. Although not shown in FIG. 3, in some examples, the device 300 may comprise a top surface, such as a lid. In these examples the lid may comprise a vent, for example to prevent an overpressure from being generated inside the device 300 when the loose build material therein is fluidized. The device 300 may comprise a removable, or a fixed, build unit of a 3D printing apparatus, e.g. as described above with reference to FIG. 2.

In some examples, a structure may be generated, e.g. according to object model data, in the additive manufacturing process that generates the solid object, such that the structure at least partially surrounds the solid object so that removal of the structure from the build bed removes the object. This is illustrated in FIG. 4, but referring again to FIG. 2, the control module 221 of the printing apparatus 290 may be to generate the structure. In other words, the control module 221 may be to control the 3D printing apparatus 290 to generate a structure that at least partially surrounds the solid object in the volume of build material (for example, by depositing fusing agent or binder agent on portions of layers of build material that are to form the structure, e.g. according to object model data). To facilitate the removal of the structure from the volume of build material, such that the object is removed with the structure, the structure comprises pores that are permeable to loose build material.

FIG. 4 shows such a structure 410. FIG. 4 shows a device 400 which may comprise any of the devices 100, 200, or 300 described above with reference to FIGS. 1-3, respectively. The device 400 comprises a sidewall 402 and a base 404 permeable to air but not to build material as described above. The device 400 is shown in FIG. 4 retaining a volume of build material 405 that comprises a solid object 408 generated by an additive manufacturing process that is at least partially surrounded by uncoalesced, loose, build material 406. In some examples, the solid object 408 may comprise a plurality of solid objects. The device 400 may be part of a build unit of a 3D printing apparatus or may be a device 400 formed around the volume 405 of build material. For example, the volume 405 of build material may be inserted, or moved to a position, into the sidewalls 402 of the device 400, effectively moving the volume 405 upwards and into the device 400, for example as described above with reference to FIG. 3. The base 404 may comprise a porous Aluminium alloy and may comprise a mesh, such as a sieve, sandwiched between two plates having pores for the passage of air. In other examples the base 204 may comprise a membrane, the membrane being permeable to air but not to build material.

The volume 405 in this example comprises a structure 410, generated by an additive manufacturing process, that at least partially surrounds the solid object 408 and such that removal of the structure 410 from the volume 405 removes the solid object 408. For example, once air is injected through the base 404 of the device 400 to fluidize the loose powder 406 in the volume 405 (as described above this may take place in the build unit of a printing apparatus in examples where the device 400 is part of a build unit, or remote from the build unit and/or the printing apparatus in other examples), the structure 410 may be removed, e.g. by a user or automatically by another means, from the volume 405 of build material and from the device 400. For example, the structure 410 may be moved in the direction of arrow C upwards and out of the volume 405. Movement of the structure 410 in the direction C may cause at least part of the structure 410 to engage the object 408 following which further movement of the structure 410 causes the object 408 to move in the same direction. In this way, removal of the structure 410 causes removal of the object 408. The structure 410 comprises pores (e.g. according to object model data describing the structure) that are permeable to build material so that when the structure 410 is removed from the build material volume 405 a minimal amount of loose build material 406 is removed with the structure 410 and the (or each) object 408. The device 400 may comprise a removable, or a fixed, build unit of a 3D printing apparatus, e.g. as described above with reference to FIG. 2.

Although not shown in FIG. 4, in some examples, the device 400 may comprise a top surface, such as a lid. In these examples the lid may comprise a vent, for example to prevent an overpressure from being generated inside the device 400 when the loose build material therein is fluidized.

FIG. 5 shows an example method 500 which may comprise of removing an object (for example a 3D object and/or an object generated in an additive manufacturing process) from a build bed and which may comprise a computer-implemented method.

Block 502 of the method comprises providing, e.g. by a processor, a volume of build material comprising an object at least partially surrounded by build material and formed in an additive manufacturing process by selectively depositing layers of the build material and causing selective areas of the build material (e.g. according to object model data describing the object) to coalesce into the object. Block 502 may comprise forming the volume of build material, e.g. in an additive manufacturing process in which the volume of build material is formed by depositing layers of build material onto a build platform and causing selective portions of layers of build material to coalesce into the object (e.g. as described above with respect of FIG. 2) or transferring a volume of build material to a device (e.g. as described above with respect to FIG. 3).

At block 504 the method comprises injecting, e.g. by a valve under the control of a controller and/or a processor, air into the volume of build material to fluidize the build material surrounding the solid object. Block 504 of the method may comprise injecting air into the volume through a base of a device retaining the volume (for example any of the devices 100-400 as described above), for example injecting air through a pore of a porous base, each pore being permeable to air but not build material, or injecting air through a membrane permeable to air but not to build material.

Block 504 may comprise injecting air at a first temperature, the temperature being selected to achieve a target temperature of the build material volume after a certain time. Block 504 may comprise selecting the temperature and/or controlling (e.g. regulating) the temperature of air (e.g. prior to injection). In this way, the temperature of the injected air may be automatically controlled.

At block 506 the method comprises removing, e.g. automatically under the control of a controller and/or processor, the object from the surrounding, fluidized, build material. Block 506 may comprise cooling the object and/or the surrounding, uncoalesced build material, via air circulating through the volume of build material. As the loose build material, once fluidized, exhibits substantially the properties of a fluid, and the circulating air through the volume cools the object and surrounding build material, block 506 comprises cooling the object and easing its removal from a build bed. As removal of the object may be performed by equipment, e.g. under the control of a controller, the removal of the object may be automatically controlled. Blocks 504 and 506 may therefore comprise automatically cooling and removing the object. In examples where a plurality of solid objects are provided in the volume of build material block 506 may comprise removing the, or each, solid object from surrounding, fluidized build material.

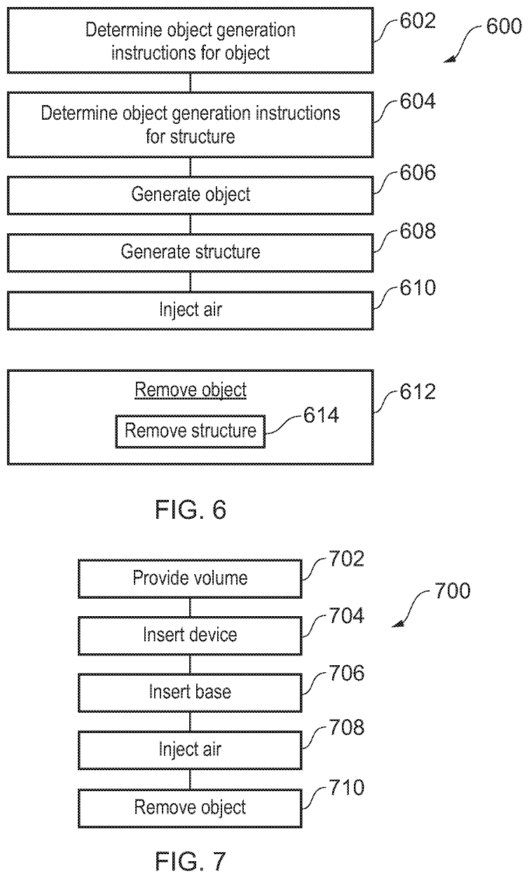

FIG. 6 shows an example method 600 which may comprise removing an object (for example a 3D object and/or an object generated in an additive manufacturing process) from a build bed and which may comprise a computer-implemented method. The method 600 may comprise a method of generating a structure to facilitate the removal of an object generated in an additive manufacturing process. The method 600 may comprise the method 500.

At block 602 the method comprises determining, e.g. by a processor, object generation instructions for generating at least part of an object by additive manufacturing. Block 602 may comprise receiving, e.g. by a processor, object model data describing at least part of the object to be generated.

At block 604 the method comprises determining, e.g. by a processor, object generation instructions for generating at least part of a structure by additive manufacturing to at least partially surround the object in the build bed. Block 604 may comprise receiving, e.g. by a processor, object model data describing at least part of the structure to be generated. Although depicted sequentially in FIG. 6 it will be appreciated that blocks 602 and 604 may performed in any order or concurrently.

The object model data describing the object and/or the structure, determined at blocks 602 and 604, respectively, may comprise data representing a portion of the object and/or the structure, respectively, to be generated by applying a coalescence agent (e.g. a fusing agent or a binder agent) selectively to a portion of a layer of build material (comprising plastic or metal particles) that will, on the application of energy, coalesce to form part of the objet and/or structure, respectively. The object model data may comprise Computer Aided Design (CAD) model, and/or may for example comprise a STereoLithographic (STL) data file, and/or may be derived therefrom. In some examples, the data may be received over a network, or received from a local memory or the like. In some examples, the data may define the shape of the part of an object, i.e. its geometry. In some examples, the data may define an appearance property, for example at least one intended colour, pattern, translucency, gloss or the like. In some examples the data may define at least one mechanical property, for example strength, density, resilience or the like. In some examples, the data may define at least one functional property, for example, conductivity in at least one object portion. Such properties may be associated with regions of the object, for example a color may be defined at an object surface.

In some examples, the object may be defined in terms of sub-volumes, each of which represents a region of the object which is individually addressable in object generation. In some examples herein, the sub-volumes may be referred to as voxels, i.e. three-dimensional pixels, wherein each voxel occupies or represents a discrete volume. In some examples of additive manufacturing, three-dimensional space may be characterised in terms of such voxels. In some examples, the voxels are determined bearing in mind the print resolution of an object generation apparatus, such that each voxel represents a region which may be uniquely addressed when applying print agents, and therefore the properties of one voxel may vary from those of neighbouring voxel(s). In other words, a voxel may correspond to a volume which can be individually addressed by an object generation apparatus (which may be a particular object generation apparatus, or a class of object generation apparatus, or the like) such that the properties thereof can be determined at least substantially independently of the properties of other voxels. For example, the ‘height’ of a voxel may correspond to the height of a layer of build material. In some examples, the resolution of an object generation apparatus may exceed the resolution of a voxel. In general, the voxels of an object model may each have the same shape (for example, cuboid or tetrahedral), but they may in principle differ in shape. In some examples, voxels are cuboids having the height of a layer of build material. In some examples, in processing object model data representing an object, each voxel may be associated with properties, and/or object generation instructions, which apply to the voxel as a whole.

In other examples, the object may be described in some other way, for example using a vector or polygon mesh-based model. In some such examples, a voxel model may be derived from another model type.

In some examples, blocks 602 and/or 604 may be carried out on a slice by slice basis. In some examples, each slice may correspond to a layer to be generated in a layer-by-layer additive manufacturing process. In some examples, such slices may be slices of a virtual build volume modelling an intended ‘real’ build volume, and may comprise slices taken from more than one object model. In some examples, the slices may be one voxel thick.

At block 606 the method comprises generating the object (e.g. according to the object model data determined, e.g. received, at block 602 of the method) and at block 608 the method comprises generating the structure (e.g. according to the object model data determined, e.g. received, at block 604 of the method). Although depicted sequentially in FIG. 6 it will be appreciated that blocks 606 and 608 may performed in any order or concurrently. Blocks 606 and/or 608 may comprise forming a layer of build material (e.g. comprising plastic or metal particles), applying print agents (e.g. coalescence agents such as a fusing agent or binder agent), for example through use of ‘inkjet’ liquid distribution technologies, in location specified in the object generation instructions for an object model slice corresponding to that layer, and applying energy, for example heat, to the layer (in examples using plastic build material) or moving the build bed to a curing station to apply energy in a curing process. Some techniques allow for accurate placement of print agent on a build material, for example by using print heads operated according to inkjet principles of two-dimensional printing to apply print agents, which in some examples may be controlled to apply print agents with a resolution of around 600 dpi, or 1200 dpi. A further layer of build material may then be formed and the process repeated, with the object generation instructions for the next slice.

Block 608 therefore comprises generating the structure from build material such that the structure at least partially surrounds the object. Therefore, blocks 606 and 608, in combination, may effectively generate the build bed (volume of coalesced and uncoalsesced build material) depicted in the example of FIG. 4).

Block 610 of the method comprises injecting air into the volume of build material to fluidize the build material surrounding the solid object and the structure, for example as described above with reference to block 504 of the method 500. Block 610 may therefore comprise injecting air into the volume through a base, for example through a pore of a porous base, each pore being permeable to air but not build material, or through a membrane permeable to air but not to build material. In these examples, the base may comprise a moveable base, for example a moveable platform of a build unit. In other words, the movable platform (e.g. the print bed) of a build unit may comprise a plurality of openings, or pores, such that the platform is permeable to air but not to build material and block 610 may comprise injecting air through the platform to fluidize the build material in the build chamber—e.g. as schematically shown in FIG. 2 as described above. Of course, in other examples between blocks 608 and 610 the build bed may be moved to a location remote from the build unit and the volume of build material may be fluidized, at block 610, at the location remote from the build unit. This will be described with reference to FIG. 7.

At block 612 the method comprises removing the object from the surrounding, fluidized, build material, for example as described above with reference to block 506 of the method 500. Block 612 comprises block 614 at which the structure is removed from the surrounding, fluidized, build material. In other words, removing the object from the build bed comprises removing the at least partially surrounding structure, for example as schematically shown in FIG. 4. Block 612 may therefore comprise cooling the object and/or the surrounding, uncoalesced build material, via air circulating through the volume of build material.

FIG. 7 shows an example method 700 which may comprise of removing an object (for example a 3D object and/or an object generated in an additive manufacturing process) from a build bed and which may comprise the methods 500 or 600 as described above. The method 700 may comprise assembling a device around a volume of build material comprising an object generated in an additive manufacturing process and at least partially surrounded by uncoalesced build material.

At block 702 the method comprises providing a volume of build material comprising an object generated in an additive manufacturing process and at least partially surrounded by uncoalesced build material, for example as described above with reference to block 502 of the method 500. Block 702 may comprise any of blocks 602 and/or 604 of the method 600. In other words, providing, at block 702, the volume of build material may comprise generating the object in an additive manufacturing process.

At block 704 the method comprises inserting a device around the volume of build material. Block 704 may comprise moving a volume of build material relative to the device such that volume of build material is inserted into the device (for example as schematically shown in FIG. 3). In another example, block 704 may comprise inserting a sidewall of a device around the volume of build material. Block 704 may comprise inserting the sidewall around the volume while the volume is in the build unit (e.g. a build chamber thereof) following an additive manufacturing process that generated the object (and therefore the build bed).

At block 706 the method comprises inserting a base into the device. The base may be a component of the device, for example a moveable and/or removable platform of the device, for example as schematically shown in the example of FIG. 3. The base is permeable to air but not to build material and therefore inserting the base, at block 705, provides a base for the device to retain the volume of build material. Together, blocks 704 and 706 therefore comprise forming an enclosure, or container, for the volume of build material. Blocks 704 and 706 therefore comprise assembling a device around the volume of build material.

At block 708 the method comprises injecting air into the volume of build material to fluidize the surrounding build material, for example as described above with reference to blocks 504 and 610 of the methods 500 and 600, respectively. Block 708 comprises injecting air through the permeable base, e.g. through a number of pores thereof, the pores being sized to prevent the passage of build material therethrough but to allow the passage of air therethrough.

At block 710 the method comprises removing the object from the surrounding, fluidized, build material, for example as described above with reference to blocks 506 and 612 of the methods 500 and 600, respectively.

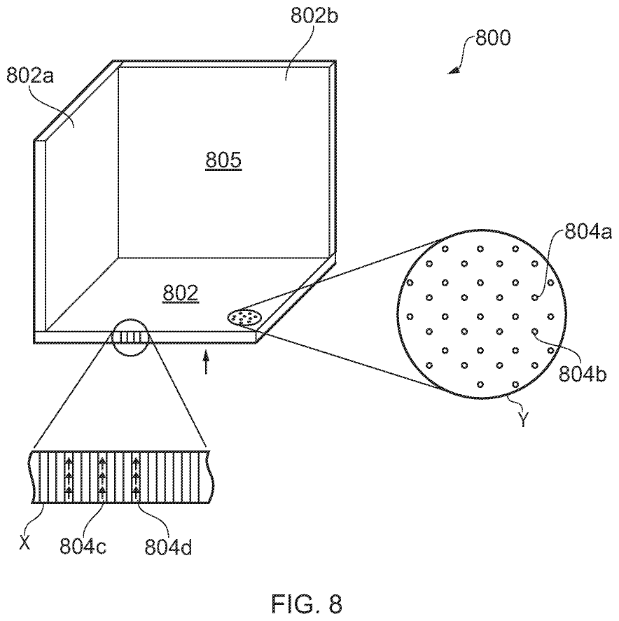

FIG. 8 schematically shows a partial cutaway view of an example apparatus 800 which may comprise any of the devices 100-400 as shown in FIGS. 1-4, respectively. The apparatus 800 is to retain a (not shown in FIG. 8) volume of build material comprising a volume of coalesced build material at least partially surrounded by loose build material (e.g. uncoalesced build material, for example as described above), e.g. following an additive manufacturing process to create the coalesced build material. The build material may comprise plastic or metal particles. The coalesced build material may comprise an object generated in an additive manufacturing process and the volume of build material may therefore comprise a build bed.

The apparatus 800 comprises an interior chamber 805, the interior chamber 805 being to receive the volume of build material comprising a volume of coalesced build material at least partially surrounded by loose build material. The apparatus 800 also comprises a platform 804, which may comprise a base of the apparatus 800, to hold and/or retain the volume of build material in the interior chamber 805 of the apparatus 800.

It will be appreciated that the interior chamber 805 may be delimited by at least one sidewall of the apparatus 800 (for example the sidewalls 102-402 as described above with reference to the devices 100-400). FIG. 8 schematically shows two such sidewalls 802a and 802b as FIG. 8 shows a partial cutaway of the apparatus 800 but it will be appreciated that this is for illustrative purposes only, and that in some examples the apparatus 800 may comprise one, curved, sidewall or any number of sidewalls.

The platform 804 of the apparatus 800 may be removable from and/or or insertable into the apparatus 800. The platform 804 may therefore be movable with respect to a remainder of the apparatus 800 (e.g. movable with respect to the sidewall 802). As stated above, the platform 804 is to retain the volume of build material in the interior chamber 805 of the apparatus 800. For this purpose, the platform 804 is not permeable to build material so that a volume of build material in the internal chamber 805 is retained in the apparatus 800 by the platform 804. The apparatus 800 may be an apparatus for facilitating removal of an object of coalesced build material formed in an additive manufacturing process and may comprise an apparatus 800 for fluidize an amount of build material in a build volume. For this purpose, the platform 804 is permeable to air to allow an influx of air into the interior chamber 805, through the platform 804, to fluidize the loose build material in a volume of build material in the interior chamber 805. In some examples, apparatus 800 may comprise a top surface, such as a lid. In these examples the lid may comprise a vent, for example to prevent an overpressure from being generated inside the device 800 when the loose build material therein is fluidized. The device 800 may comprise a removable, or a fixed, build unit of a 3D printing apparatus, e.g. as described above with reference to FIG. 2.

FIG. 8 shows two exploded views of different parts of the platform 804. Exploded view X shows an enlarged cutaway through a side of the platform 804 and exploded view Y shows an enlarged view of a top surface of the platform 804, the top surface of the platform 804 being the surface that is to come into contact with a volume of build material to retain the volume in the chamber 805. The two exploded views show that the platform 804 comprises a plurality of openings (four of which are labelled for simplicity, as 804a-d) and each opening is sized to allow the passage of air therethrough, as indicated by the arrows in the exploded view X. However, the openings are sized to prevent the flow of build material therethrough so that the platform 804 can retain a volume of build material in the interior chamber 805 of the apparatus 800. As stated above, the passage of air upwards through the openings and into the chamber 805 may fluidize a volume of build material therein, for example fluidize loose build material at least partially surrounding a solid object of coalesced build material in the volume, to facilitate the cooling and removal of the coalesced objet from surrounding loose build material. Each opening, in one example, may comprise a diameter 50 μm or less.

As described above with reference to the devices 100-400, the apparatus 800 may be assembled around the volume of build material, e.g. by inserting a sidewall 802 at least partially around a volume of build material and then inserting the platform 804 therethrough. In this example the volume of build material may be removed from a build unit of a 3D printing apparatus and the build material fluidized, and the object removed, at a location remove from the 3D printing apparatus (for example as described above with reference to FIG. 3). In another examples, the apparatus 800 may comprise a build unit of a 3D printing apparatus, and the platform 804 may comprise the movable platform of the build unit and the interior chamber 805 may comprise the build chamber of the build unit. In this example the build material may be fluidized, and the object removed, immediately following a print job which generates the object (for example as described above with reference to FIG. 2).

Some examples herein therefore relate to cooling 3D printed parts that are embedded in a bed of, uncoalesced, unfused, powdered build material by fluidizing the build material, and facilitating the removal of the printed parts from the powder bed. Fluidizing is achieved through the injection of air into the powder bed which may also cool the unfused, loose, powdered build material around the 3D printed part. This allows for a better control of the cooling rate at which the 3D printed parts cool down, and a method of easily removing non-coalesced powder around the printed parts which can be easily automated. A better control over the cooling process may allow for a better control over the part dimensions. For example, the temperature and type of air injected into the powder volume for the fluidification of the loose powder may be controller. Furthermore, fluidizing the powdered build material may allow for a more gentle removal of the printed part from loose build material to reduce the instances of the part breaking during its removal (and/or de-caking).

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A device comprising:
a sidewall; and
a base,
wherein the sidewall and the base define a chamber for receipt of a volume of build material comprising loose build material and a solid object generated from the build material in an additive manufacturing process, and
wherein the base is not permeable to build material but is permeable to a gas to allow an influx of the gas into the chamber to fluidize loose build material around the solid object in the volume of build material in the chamber to facilitate the removal of the solid object from the loose build material.

2. A device according to claim 1, wherein the device comprises a build unit of a 3D printing apparatus, wherein the base comprises a moveable base of the build unit to receive a layer of build material in an additive manufacturing process.

3. A device according to claim 1, wherein the base is removable from the device.

4. A device according to claim 1 further comprising a gas source to inject the gas into the volume of build material through the base.

5. A device according to claim 1, wherein the device comprises a 3D printing apparatus, and wherein the device further comprises:
processing circuitry comprising:
a control module to control the 3D printing apparatus to generate the solid object by selectively causing portions of successive layers of build material to coalesce, and wherein the control module is to control the 3D printing apparatus to generate a structure that at least partially surrounds the solid object in the volume of build material, the structure having pores permeable to loose build material.

6. A device according to claim 1 wherein the device is insertable around the volume of build material.

7. A method comprising:
providing a volume of build material, wherein the volume of build material comprises an object at least partially surrounded by build material, the object being formed in an additive manufacturing process by selectively depositing layers of the build material and causing selective areas of the build material to coalesce into the object;
injecting a gas into the volume of build material to fluidize the surrounding build material; and
removing the object from the surrounding build material.

8. A method according to claim 7, further comprising:
generating the object in an additive manufacturing process by selectively depositing layers of the build material on a moveable platform, the moveable platform comprising pores not permeable to build material but permeable to the gas, and causing selective areas of the build material to coalesce into the object;
wherein injecting the gas into the volume of build material to fluidize the surrounding build material comprises injecting the gas into the volume of build material through a pore of the moveable platform.

9. A method according to claim 7, further comprising:
inserting a device around the volume of build material;
inserting a base, permeable to a gas but not to build material, into the device to form a platform to retain the volume of build material;
injecting the gas through the permeable base to fluidize the volume of powder; and
wherein removing the object from the surrounding build material comprises:
removing the object from the device.

10. A method according to claim 7 further comprising
determining object generation instructions to generate a structure from build material at least partially surrounding the object.

11. A method according to claim 10, further comprising:
generating the structure from the object generation instructions,
and wherein removing the object from the surrounding build material comprises:
removing the structure from the volume of build material.

12. An apparatus for retaining a volume of build material comprising a volume of coalesced build material at least partially surrounded by loose build material, the apparatus comprising:
an interior chamber to receive the volume of build material;
a platform to hold the volume of build material in the interior chamber, wherein the platform comprises a plurality of openings sized to prevent the flow of build material therethrough but sized to allow the passage of a gas therethrough to fluidize the loose build material in the volume of build material to facilitate the removal of the coalesced build material from the surrounding loose build material.

13. An apparatus according to claim 12, wherein the interior chamber comprises a build chamber of a build unit of a 3D printing apparatus.

14. An apparatus according to claim 13, wherein the platform comprises the moveable platform of the build unit.

15. An apparatus according to claim 12, wherein the platform is insertable into, and removable from, the apparatus.
